(19) United States
(12) Patent Application Publication
(10) Pub. No.: US 2012/0062501 A1
(43) Pub. Date: Mar. 15, 2012

(54) SYSTEM AND METHOD OF RECOGNIZING A TOUCH EVENT ON TOUCH PAD BY MEASURING TOUCH AREA OF TOUCH SENSITIVE SURFACE OF THE TOUCH PAD

(75) Inventor: CHIH-HSIEN YAO, Ta Ya Shiang (TW)

(73) Assignee: Sunrex Technology Corp., Ta Ya Shiang (TW)

(21) Appl. No.: 12/879,292

(22) Filed: Sep. 10, 2010

(51) Int. Cl. G06F 3/045

(52) U.S. Cl. 345/174

(57) ABSTRACT

System and method of recognizing a touch event on a resistive touch pad having virtual keys are provided. The system includes a touch sensitive unit in the touch pad; a touch area calculation unit; and a microprocessor. In response to pressing the one of the virtual keys by an object, the touch area calculation unit measures a touch area of the object on the virtual key, the touch area is compared with a predetermined value, the touch area calculation unit generates a touch signal if the touch area is greater than the predetermined value, the touch signal is transmitted to the microprocessor, after receiving the touch signal, the microprocessor generates a key code corresponding to the virtual key being pressed, and the key code is transmitted to a computer for further processing to recognize the touch event.

### BACKGROUND OF THE INVENTION

1. Field of Invention

The invention relates to a touch pad and more particularly to a system and method of recognizing a touch event on a touch pad by measuring a touch area of a touch sensitive surface of the touch pad.

2. Description of Related Art

Touchscreens and touch pads as input devices are becoming increasingly popular in the fields of computers, cellular phones, etc. because of their ease and versatility of operation. For example, touch pad allows a user to make selections and move a cursor by simply moving one finger thereon. It is similar to computer mouse operation.

There are several types of touchscreen and touch pad technologies including resistive, capacitive, surface acoustic wave, infrared, near field imaging, etc. Each of these devices has advantages and disadvantages. For example, there are 4-wire resistive touchscreens, 5-wire resistive touchscreens, and 8-wire resistive touchscreens. In particular, 4-wire resistive touchscreens have about half of the market share because of the mature technology and cost consideration. For a typical 4-wire resistive touchscreen, one sheet is ITO (Indium Tin Oxide) glass, the other sheet is ITO film, and an insulating spacer for separation is disposed therebetween. For example, during operation of the four-wire resistive touchscreen, a +5V voltage is applied to the ITO glass. When the two sheets are pressed together by finger, stylus/pen, or palm, the ITO film measures the voltage as distance along the ITO glass, providing the X coordinate. When this contact coordinate has been acquired, the +5V voltage is applied to the ITO film to ascertain the Y coordinate. This operation occurs instantaneously, registering the exact touch location as contact is made.

One prior literature discloses a touchscreen apparatus and a touch method by using same. In detail, it comprises a touchscreen for a user pressing, a pressure sensor for sensing pressure from the touchscreen and generating a touch signal as touch event, and a microprocessor for processing the touch signal and sending a data about the touch event to a display which in turn performs an action based on the touch event.

Another prior literature discloses a method of controlling a multipoint touchscreen. In detail, it comprises a resistive touchscreen in which a contact sequence of first and second contact members is determined by a time difference between the first contact member contacting the touchscreen and the second contact member contacting the touchscreen. Further, a first contact coordinate and at least one real coordinate are determined by the sensing voltage applied onto the touchscreen. The first contact member continues to contact the touchscreen. Moving directions and distances can be obtained by calculating the differences between two coordinates and they are used for issuing at least one instruction.

However, prior art techniques are directed to pressure sensing on touch sensitive surface of the touchscreen. Also, pressure magnitude determines voltage change of the internal resistive components. No disclosure of measuring a touch area of a touch sensitive surface of the touchscreen and voltage change caused by the touch event when a finger or palm presses the touchscreen. It is found that typical touchscreens are either too sensitive or insensitive to touch. Thus, the need for improvement still exists.

### SUMMARY OF THE INVENTION

It is therefore one object of the invention to provide a system of recognizing a touch event on a resistive touch pad, comprising a plurality of virtual keys printed on the touch pad; touch sensitive means responsive to pressing one of the virtual keys by an object and disposing in the touch pad; a touch area calculation unit electrically connecting to the touch pad, and a microprocessor electrically connecting to the touch area calculation unit, wherein the touch area calculation unit measures a touch area of the object on the virtual key, the touch area is compared with a predetermined value, the touch area calculation unit generates a touch signal if the touch area is greater than the predetermined value, the touch signal is transmitted to the microprocessor, after receiving the touch signal, the microprocessor generates a key code corresponding to the virtual key being pressed, and the key code is transmitted to a computer which converts the key code into a touch event and subsequently performs an action based on the touch event.

It is another object of the invention to provide a method of recognizing a touch event on a touch pad, comprising the steps of causing a microprocessor to continuously scan the touch pad for sensing whether there is a pressing on the touch pad by an object or not after turning on a computer; causing a touch area calculation unit to measure a touch area of the object on one of a plurality of virtual keys of the touch pad if the sensing is positive wherein the touch area is represented by dots, and wherein each virtual key is represented by a predetermined plurality of dots; causing the touch area calculation unit to generate a touch signal if a percentage of the dots of the touch area divided by predetermined total dots of each virtual key is greater than a predetermined percentage; and transmitting the touch signal to the microprocessor; after receiving the touch signal, causing the microprocessor to generate a key code corresponding to the virtual key being pressed; and transmitting the key code to a computer which converts the key code into a touch event and subsequently performs an action based on the touch event.

The above and other objects, features and advantages of the invention will become apparent from the following detailed description taken with the accompanying drawings.

### BRIEF DESCRIPTION OF THE DRAWINGS

FIG. 1 is a perspective view of a touch pad according to the invention with a finger touching the touch pad;

FIG. 2A is an enlarged view of the circle B in FIG. 1;

FIG. 2B is a view similar to FIG. 2A showing the area of the circle B being increased because a great force is exerted by a finger;

FIG. 3A is a sectional view taken along line A-A of FIG. 1;

FIG. 3B is a view similar to FIG. 3A showing a recess on the touch pad generated by a touch corresponding to FIG. 2A;

FIG. 3C is a view similar to FIG. 3A showing three recesses on the touch pad generated by a great force exerted thereon by the finger corresponding to FIG. 2B;

FIG. 4 is a block diagram of processing the touch by the touch pad and a computer associated therewith according to the invention; and

FIG. 5 is a flow chart diagram illustrating how to process a touch on the touch pad according to the invention.

### DETAILED DESCRIPTION OF THE INVENTION

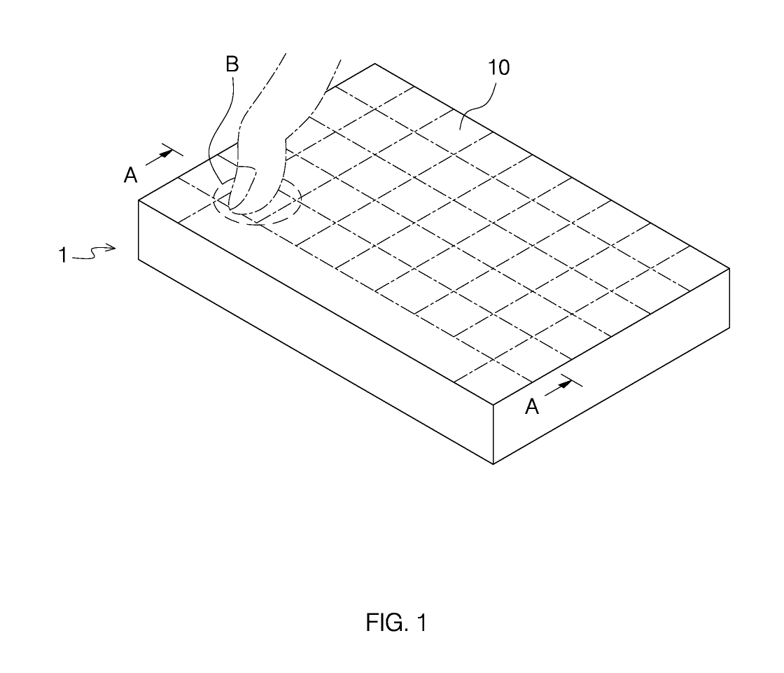

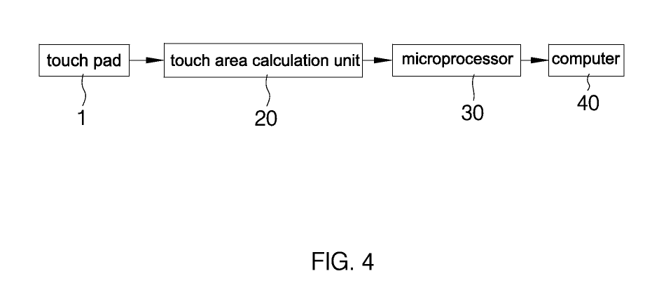

Referring to FIGS. 1 to 4, a system of recognizing a touch event on a computer input device in accordance with the invention is shown. The system comprises the following components as discussed in detail below.

A parallelepiped touch pad 1 comprises a printing layer (not numbered) adhesively attached on a top surface. The printing layer comprises a plurality of characters and/or numerals as virtual keys 10 arranged in matrix and printed thereon. The system further comprises a circuitry (i.e., controller) including a touch area calculation unit 20 and a microprocessor 30. The circuitry is provided as a part of the circuitry of a keyboard.

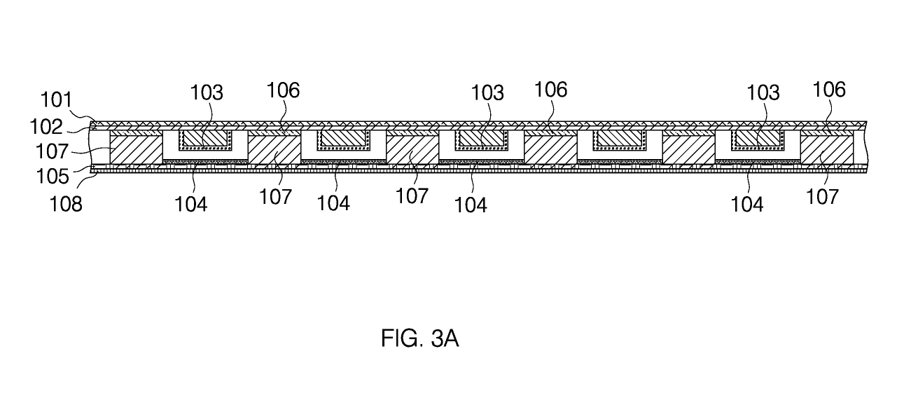

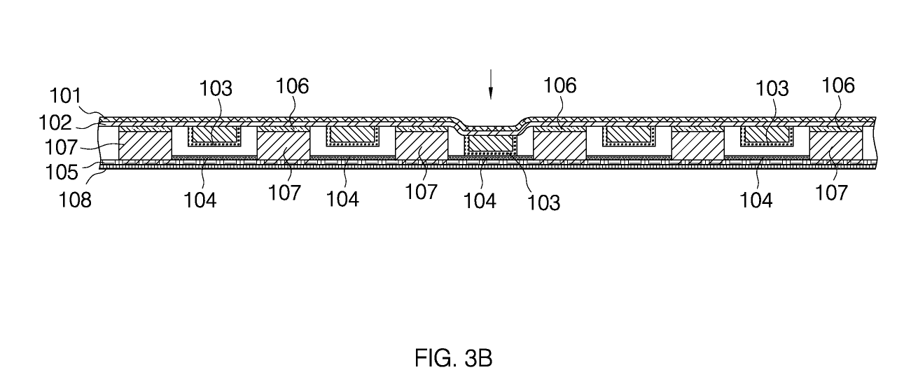

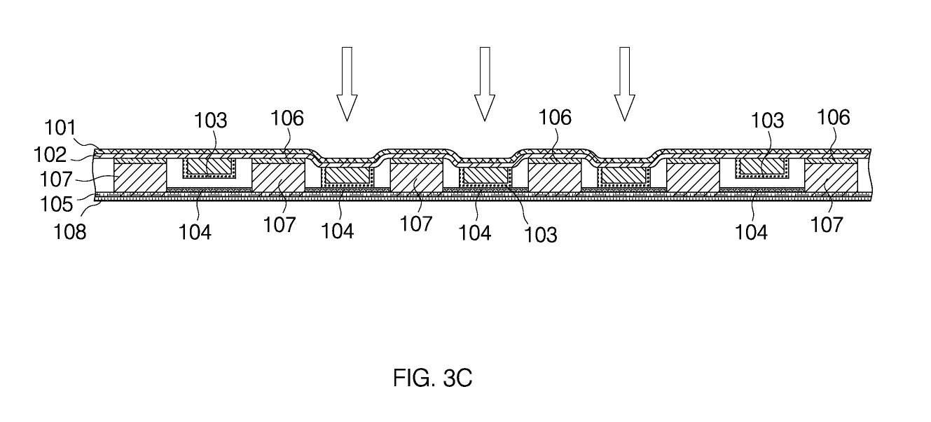

As shown in FIGS. 1 and 3A, the touch pad 1 is a resistive touch pad and comprises, from top to bottom, a top substrate 101 made of PET (polyethylene terephthalate), a first conduction layer 102 adhered to the top substrate 101, a first sensing layer 103 made of sensing material and adhered to the first conduction layer 102, the first sensing layer 103 projecting downward, a second sensing layer 104 made of sensing materials and spaced apart from the first sensing layer 103 by a distance, a second conduction layer 105 adhered to the second sensing layer 104, and a bottom substrate 108 made of PET.

Between the first conduction layer 102 and the second conduction layer 105, there are provided a plurality of posts 107 as spacers. The post 107 has a bottom end adhered to the second conduction layer 105 and a top end secured to the first conduction layer 102 by means of an adhesive layer 106. The posts 107 and the first sensing layers 103 are arranged transversely in alternating fashion.

The touch pad 1 is electrically connected to the touch area calculation unit 20 which is in turn electrically connected to the microprocessor 30. The touch area calculation unit 20 is activated when the computer system is turned on.

Each virtual key 10 is comprised of a plurality of dots arranged as a matrix. Each dot can be expressed by Cartesian coordinates (X, Y). That is, there are X×Y dots. For example, a first dot can be expressed by Cartesian coordinates (X1, Y1). In an exemplary example, a virtual key 10 occupying 1 cm square can be divided into 10×10 dots.

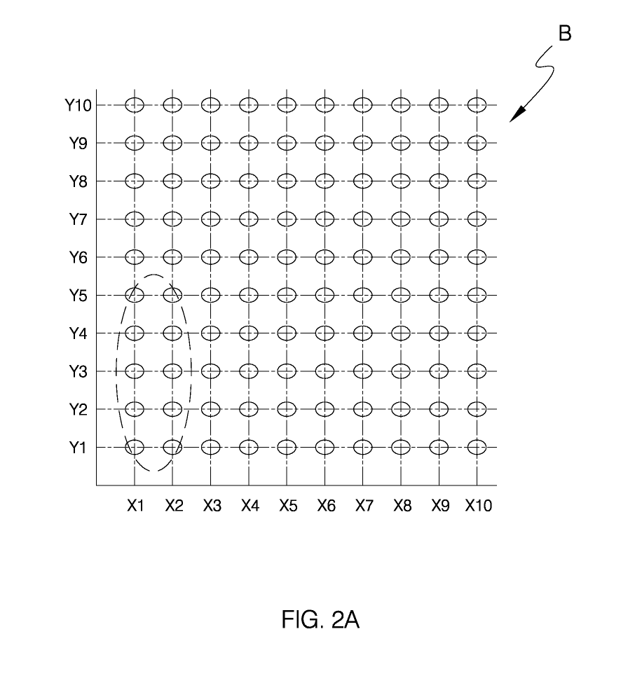

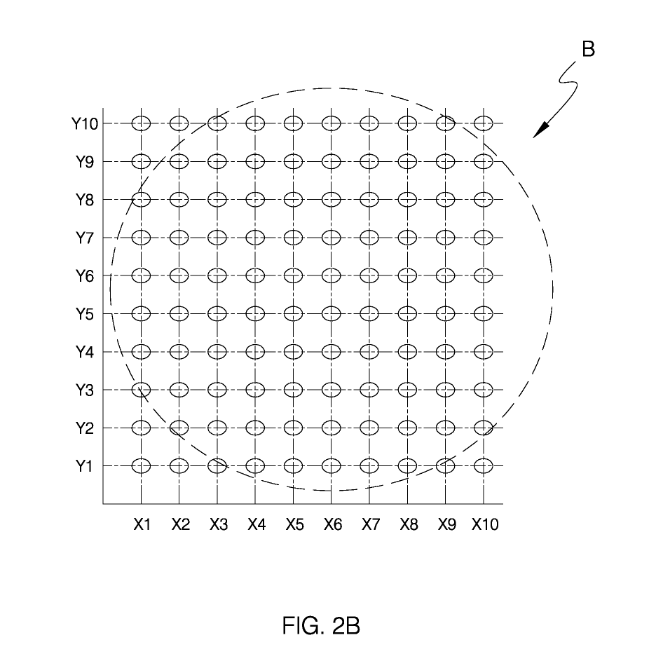

As shown in FIGS. 2A and 3B, a user may place the finger on the top substrate 101 of the touch pad 1 (i.e., touch). As shown, a small arrow means a small area on the touch pad 1 touched by the finger and thus only a small portion of the virtual key 10 on the top substrate 101 is recessed. It is noted that dots in the shaded area B are considered as being touched or pressed by the finger.

As shown in FIG. 2A, 10 dots of 100 dots of the virtual key 10 are touched by the finger. A touch signal will be generated by the touch area calculation unit 20 if the number of dots in the shaded area B divided by total dots of the virtual key 10 expressed by percentage exceeds a predetermined percentage. In this embodiment, the predetermined percentage is 80%. Hence, the touch area calculation unit 20 will not generate a touch signal because the number of dots in the shaded area B (i.e., 10 dots) divided by total dots of the virtual key 10 (i.e., 100 dots) expressed by percentage is 10% which is much less than 80%.

As shown in FIGS. 2B and 3C, a user may exert a great force to press the finger on the top substrate 101 of the touch pad 1. As shown, three large arrows means a large area on the touch pad 1 pressed by the finger and thus a large portion of the virtual key 10 on the top substrate 101 is recessed. It is noted that dots in the shaded area B are considered as being touched or pressed by the finger.

As shown in FIG. 2B, 90 dots of 100 dots of the virtual key 10 are pressed by the finger. In this embodiment, the predetermined percentage is 80%. Hence, the touch area calculation unit 20 will generate a touch signal because the number of dots in the shaded area B (i.e., 90 dots) divided by total dots of the virtual key 10 (i.e., 100 dots) expressed by percentage is 90% which is greater than 80%.

The touch pad 1 of the invention resistive. The touch pad 1 comprises, from top to bottom, a top substrate 101 made of PET, a first conduction layer 102 adhered to the top substrate 101, a first sensing layer 103 made of sensing material and adhered to the first conduction layer 102, the first sensing layer 103 projecting downward, a second sensing layer 104 made of sensing materials and spaced apart from the first sensing layer 103 by a distance, a second conduction layer 105 adhered to the second sensing layer 104, and a bottom substrate 108 made of PET.

The first sensing layer 103 contacting the second sensing layer 104 will change voltage therebetween in response to finger pressing on the virtual key 10. But a touch signal will be generated only when a sufficient voltage drop is obtained by the contact (i.e., passing a threshold voltage value). For example, as shown in FIG. 3B, a touch of the virtual key 10 only causes one contact between the first sensing layer 103 and the second sensing layer 104. Thus, no sufficient voltage drop is obtained by the contact, i.e., not passing a threshold voltage value with no touch signal being generated. To the contrary, as shown in FIG. 3C, a pressing of the virtual key 10 causes a plurality of (e.g., three) contacts between the first sensing layers 103 and the second sensing layers 104. Thus, a sufficient voltage drop is obtained by the contact, i.e., passing the threshold voltage value (i.e., the predetermined percentage of 80%) with a touch signal being generated.

After receiving the touch signal from the touch area calculation unit 20, the microprocessor 30 may generate a key code corresponding to the virtual key 10 being pressed. The key code is next transmitted to a computer 40 via a USB (Universal Serial Bus) port. The computer 40 next runs programs to convert the key code into a touch event and subsequently performs an action based on the touch event.

It is contemplated by the invention that a precise recognition of a touch on the virtual key 10 can be made by measuring a touch area of the top substrate 101 (i.e., a touch sensitive surface) of the touch pad 1. This thus eliminates the disadvantage of the prior art touchscreens of being either too sensitive or insensitive to touch.

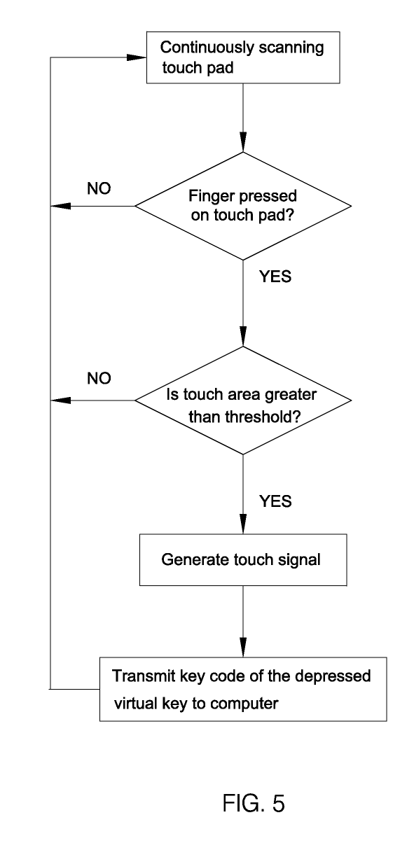

Referring to FIG. 5, a flow chart diagram illustrates how to process a touch on the touch pad 1 according to the invention. In detail, the microprocessor 30 continuously scans the touch pad 1 for sensing whether there is a touch on the touch pad 1 by the hand or not after turning on the computer 40. If yes, the touch area calculation unit 20 measures a touch area of the finger on a certain virtual key 10 of the touch pad 1. The measurement (i.e., area) is compared with a predetermined value (i.e., a threshold value). If the area is greater than the predetermined value, the touch area calculation unit 20 generates a touch signal. The touch signal is next transmitted to the microprocessor 30. After receiving the touch signal from the touch area calculation unit 20, the microprocessor 30 may generate a key code corresponding to the virtual key 10 being pressed. The key code is next transmitted to a computer 40. The computer 40 next runs programs to convert the key code into a touch event and subsequently performs an action based on the touch event.

The above description is directed to a single touch. Advantageously, the invention is also applicable to multipoint touch (i.e., configured to recognize multiple touch events that occur at different locations on the top substrate 101 of the touch pad 1 at the same time.) That is, the touch pad 1 allows for multiple touch points on the virtual keys 10 to be tracked simultaneously. The separate touch signals for touch points are generated by the virtual key 10 and the touch signals can be processed by the microprocessor 30. In short, the touch pad 1 is a multipoint touch pad.

It is noted that the principles of the invention are also applicable to touchscreens.

While the invention has been described in terms of preferred embodiments, those skilled in the art will recognize that the invention can be practiced with modifications within the spirit and scope of the appended claims.

What is claimed is:

1. A system of recognizing a touch event on a resistive touch pad, comprising:
a plurality of virtual keys printed on the touch pad;
touch sensitive means responsive to pressing one of the virtual keys by an object and disposing in the touch pad;
a touch area calculation unit electrically connecting to the touch pad, and
a microprocessor electrically connecting to the touch area calculation unit;
wherein the touch area calculation unit measures a touch area of the object on the virtual key, the touch area is compared with a predetermined value, the touch area calculation unit generates a touch signal if the touch area is greater than the predetermined value, the touch signal is transmitted to the microprocessor, after receiving the touch signal, the microprocessor generates a key code corresponding to the virtual key being pressed, and the key code is transmitted to a computer which converts the key code into a touch event and subsequently performs an action based on the touch event.

2. The system of claim 1, wherein each virtual key is comprised of a plurality of dots, each expressed by Cartesian coordinates (X, Y), and wherein the touch area measured by the touch area calculation unit represented by the dots.

3. The system of claim 2, wherein the dots representing the touch area are divided by predetermined total dots of each virtual key to obtain a percentage, wherein the touch event is recognized by the system if the percentage is greater than a predetermined percentage derived from the predetermined value, and wherein the predetermined percentage is 80%.

4. The system of claim 1, wherein the touch sensitive means comprises a top substrate, a first conduction layer adhered to the top substrate, a first sensing layer adhered to the first conduction layer, the first sensing layer projecting downward, a second sensing layer spaced from the first sensing layer by a predetermined distance, a second conduction layer adhered to the second sensing layer, and a bottom substrate.

5. The system of claim 4, further comprising a plurality of posts disposed between the first conduction layer and the second conduction layer, each of the posts having a bottom end adhered to the second conduction layer and a top end secured to the first conduction layer by means of an adhesive layer, and wherein the posts and the first sensing layers are arranged transversely in alternating fashion.

6. The system of claim 4, wherein each of the top and bottom substrates is formed of PET (polyethylene terephthalate).

7. A method of recognizing a touch event on a touch pad, comprising the steps of:
causing a microprocessor to continuously scan the touch pad for sensing whether there is a pressing on the touch pad by an object or not after activating the touch pad;
causing a touch area calculation unit to measure a touch area of the object on one of a plurality of virtual keys of the touch pad if the sensing is positive wherein the touch area is represented by dots, and wherein each virtual key is represented by a predetermined plurality of dots;
causing the touch area calculation unit to generate a touch signal if a percentage of the dots of the touch area divided by predetermined total dots of each virtual key is greater than a predetermined percentage; and
transmitting the touch signal to the microprocessor;
after receiving the touch signal, causing the microprocessor to generate a key code corresponding to the virtual key being pressed; and
transmitting the key code to a computer which converts the key code into a touch event and subsequently performs an action based on the touch event.

8. The method of claim 7, wherein each virtual key is comprised of a plurality of dots, each expressed by Cartesian coordinates (X, Y), and wherein the predetermined percentage is 80%.

9. The method of claim 7, wherein the touch pad comprises a top substrate, a first conduction layer adhered to the top substrate, a first sensing layer adhered to the first conduction layer, the first sensing layer projecting downward, a second sensing layer spaced from the first sensing layer by a predetermined distance, a second conduction layer adhered to the second sensing layer, a bottom substrate, and a plurality of posts disposed between the first conduction layer and the second conduction layer, each of the posts having a bottom end adhered to the second conduction layer and a top end secured to the first conduction layer by means of an adhesive layer, and wherein the posts and the first sensing layers are arranged transversely in alternating fashion.
